(19) United States
(12) Patent Application Publication
(10) Pub. No.: US 2015/0103222 A1
(43) Pub. Date: Apr. 16, 2015

(54) METHOD FOR ADJUSTING PREVIEW AREA AND ELECTRONIC DEVICE THEREOF

(71) Applicant: Samsung Electronics Co., Ltd., Suwon-si (KR)

(72) Inventors: Hong-Suk CHOI, Suwon-si (KR); Moon-Soo KIM, Seoul (KR); Dae-Jung HAN, Suwon-si (KR)

(21) Appl. No.: 14/511,685

(22) Filed: Oct. 10, 2014

(30) Foreign Application Priority Data
Oct. 15, 2013 (KR) 10-2013-0122875

(51) Int. Cl. H04N 5/232

(52) U.S. Cl. CPC H04N 5/23216; H04N 5/23293
USPC 348/333.05

(57) ABSTRACT

An operating method of adjusting a preview area of images of an electronic device equipped with a dual camera is provided. The method includes determining whether a coordinate value of a current frame and an immediately previous frame among a plurality of frames configuring a first image has a change of less than a set value, adjusting a preview area of the first image to match a preview area of the current frame and a preview area of the immediately previous frame when it is determined that the there is the change of less than the set value, and adjusting a preview area of a second image by using a coordinate value adjusting the preview area of the first image.

### CROSS-REFERENCE TO RELATED APPLICATION(S)

This application claims the benefit under 35 U.S.C. §119(a) of a Korean patent application filed on Oct. 15, 2013 in the Korean Intellectual Property Office and assigned Serial number 10-2013-0122875, the entire disclosure of which is hereby incorporated by reference.

### TECHNICAL FIELD

The present disclosure relates to a method for adjusting a preview image and an electronic device thereof.

### BACKGROUND

Due to the development of information communication technology and semiconductor technology, various electronic devices are developing into multimedia devices providing various multimedia services. For example, the electronic devices provide various multimedia services such as voice call services, video call services, messenger services, broadcasting services, wireless interne services, camera services, and music playback services.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a device and method for reducing power consumption of an electronic device by adjusting a preview image of a second image by using a coordinate value adjusting a preview image of a first image and also adjusting the preview area of the first image simultaneously if it is determined that a current preview area of the first image and an immediately previous preview area have a change in a coordinate value of less than a set value.

Another aspect of the present disclosure is to provide a device and method for improving a processing speed of an electronic device as a preview area of a second image is adjusted by using a coordinate value adjusting a preview area of a first image.

According to an aspect of the present disclosure, an operating method of adjusting a preview area of images of an electronic device equipped with a dual camera is provided. The method includes determining whether a coordinate value of a current frame and an immediately previous frame among a plurality of frames configuring a first image has a change of less than a set value, adjusting a preview area of the first image to match a preview area of the current frame and a preview area of the immediately previous frame when it is determined that the there is the change of less than the set value, and adjusting a preview area of a second image by using a coordinate value adjusting the preview area of the first image.

According to another aspect of the present disclosure, an electronic device equipped with a dual camera is provided. The electronic device includes a processor configured to determine whether a coordinate value of a current frame and an immediately previous frame among a plurality of frames configuring a first image has a change of less than a set value, to adjust a preview area of the first image to match a preview area of the current frame and a preview area of the immediately previous frame when it is determined that the there is the change of less than the set value, and to adjust a preview area of a second image by using a coordinate value adjusting the preview area of the first image, and a memory configured to storie data controlled by the processor.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure;

FIG. 2 is a block diagram of hardware according to an embodiment of the present disclosure;

FIG. 3 is a block diagram of a programming module according to an embodiment of the present disclosure;

FIG. 4 is a block diagram illustrating a configuration of an electronic device according to an embodiment of the present disclosure;

FIGS. 5A, 5B and 5C are views illustrating an operation for adjusting a preview area of an image captured by a first camera according to an embodiment of the present disclosure;

FIGS. 6A, 6B and 6C are views illustrating an operation for adjusting a preview area of a second image by using a coordinate value adjusting a preview area of a first image according to an embodiment of the present disclosure;

FIG. 7 is a flowchart illustrating an operation order of an electronic device according to an embodiment of the present disclosure; and

FIG. 8 is a flowchart illustrating a method of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to an embodiment of the present disclosure may be a device having a communication function. For example, the electronic device may be at least one or a combination of a smart phone, a tablet personal computer (PC), a mobile phone, a video phone, an e-book reader, a desktop PC, a laptop PC, a netbook computer, personal digital assistant (PDA), a portable multimedia player (PMP), an MPEG-1 or MPEG-2 Audio Layer III (MP3) player, a mobile medical device, an electronic bracelet, an electronic necklace, an electronic appcessory, a camera, a wearable device, an electronic clock, a wrist watch, smart white appliance (e.g., a refrigerator, an air conditioner, a vacuum cleaner, an artificial intelligence robot, a television (TV), a digital video disk (DVD) player, an audio system, an oven, a microwave, a washing machine, an air purifier, and a digital photo frame), various medical devices (e.g., magnetic resonance angiography (MRA), magnetic resonance imaging (MRI), computed tomography (CT), tomography, and ultrasonograph), a navigation device, a global positioning system (GPS) receiver, an event data recorder (EDR), a flight data recorder (FDR), a set-top box, a TV box (e.g., Samsung HomeSync™, Apple TV™, or a Google TV™), an electronic dictionary, a vehicle infotainment device, electronic equipment for ship (e.g., a navigation device for ship and a gyro compass), avionics, a security device, an electronic garment, an electronic key, a camcorder, a game console, head-mounted display (HMD), a flat panel display device, an electronic album, part of a furniture or building/structure including a communication function, an electronic board, an electronic signature receiving device, and a projector. It is apparent to those skilled in the art that the electronic device is not limited to the above-mentioned devices.

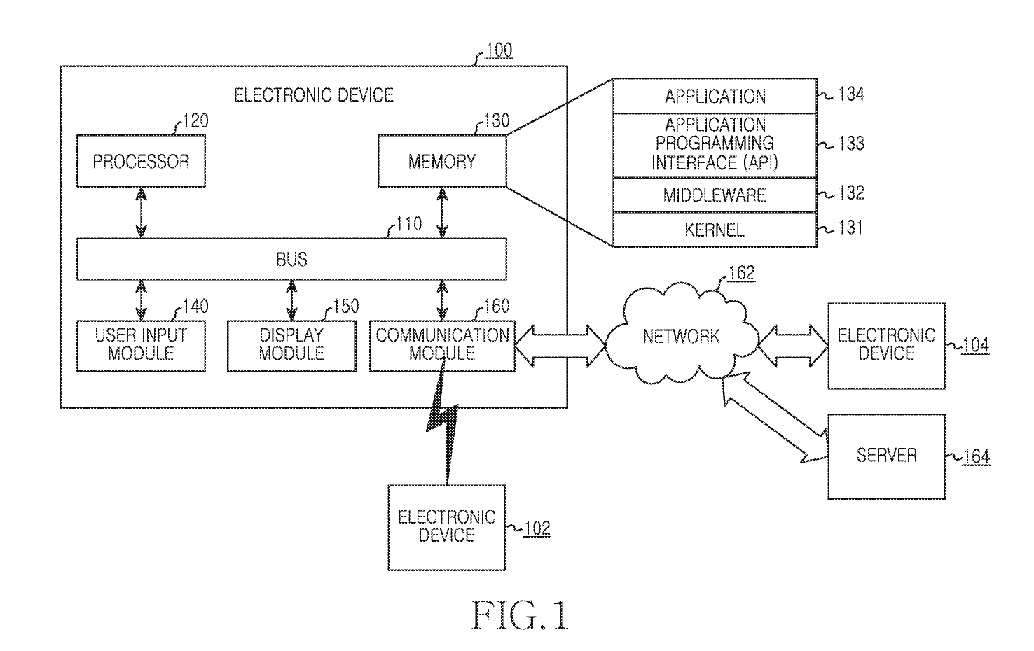

FIG. 1 is a block diagram illustrating an electronic device according to an embodiment of the present disclosure.

Referring to FIG. 1, the electronic device 100 may include a bus 110, a processor 120, a memory 130, a user input module 140, a display module 150, and a communication module 160, but is not limited thereto.

The bus 110 may be a circuit connecting the above-mentioned components to each other and delivering a communication (e.g., a control message) therebetween.

The processor 120 receives an instruction from the above other components (e.g., the memory 130, the user input module 140, the display module 150, and the communication module 160) through the bus 110, interprets the received instruction, and performs operations and data processing in response to the interpreted instruction.

The memory 130 may store an instruction and/or data received from the processor 120 and/or other components (e.g., the user input module 140, the display module 150, and the communication module 160) and/or an instruction and/or data generated from the processor 120 and/or other components. The memory 130 may include programming modules, for example, a kernel 131, a middleware 132, an application programming interface (API) 133, and an application 134. Each of the above-mentioned programming modules may be configured with software, firmware, hardware, or a combination thereof.

The kernel 131 may control or manage system resources (e.g., the bus 110, the processor 120, and/or the memory 130) used for performing operation or functions implemented by the remaining other programming modules, for example, the middleware 132, the API 133, or the application 134. Additionally, the kernel 131 may provide an interface for accessing an individual component of the electronic device 100 from the middleware 132, the API 133, or the application 134 and controlling or managing the electronic device 100.

The middleware 132 may serve as an intermediary role for exchanging data between the API 133 or the application 134 and the kernel 131 through communication. Additionally, in relation to job requests received from a plurality of applications 134, the middleware 132 may perform load balancing on the job requests by using a method of assigning a priority for using a system resource (e.g., the bus 110, the processor 120, and/or the memory 130) to at least one application among the plurality of applications 134.

The API 133, as an interface through which the application 134 controls a function provided from the kernel 131 or the middleware 132, may include at least one interface or function for file control, window control, image processing, or character control.

The user input module 140 may receive an instruction and/or data from a user and deliver the instruction and/or data to the processor 120 and/or the memory 130 through the bus 110. The display module 150 may display an image, video, and/or data to a user.

The communication module 160 may connect a communication between another electronic device 102 and the electronic device 100. The communication module 160 may support a predetermined short range communication protocol (e.g., Wifi, Bluetooth (BT), near field communication (NFC)) or a predetermined network communication 162 (e.g., Internet, local area network (LAN), wire area network (WAN), telecommunication network, cellular network, satellite network or plain old telephone service (POTS)). Each of the electronic devices 102 and 104 and server 164 may be identical to (e.g., the same type) or different from (e.g., a different type) the electronic device 100.

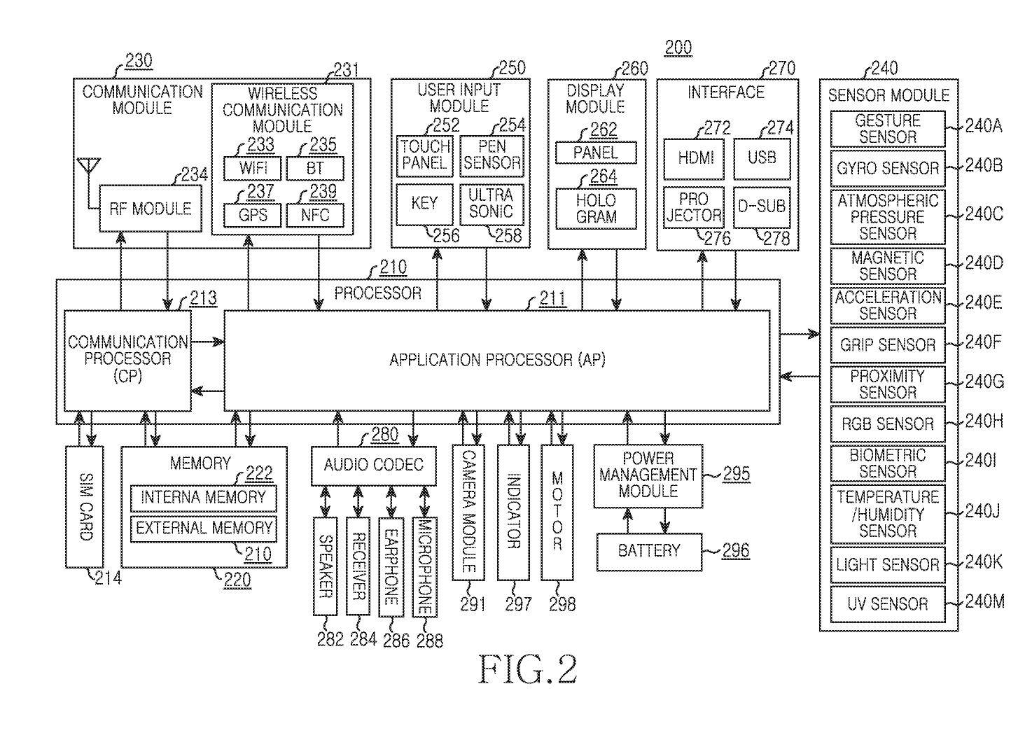

FIG. 2 is a block diagram of hardware according to an embodiment of the present disclosure.

Referring to FIG. 2, a hardware 200 may be the electronic device 100 shown in FIG. 1, for example. The hardware 200 includes at least one processor 210, a Subscriber Identification Module (SIM) card 214, a memory 220, a communication module 230, a sensor module 240, a user input module 250, a display module 260, an interface 270, an audio Coder-DECoder (CODEC) 280, a camera module 291, a power management module 295, a battery 296, an indicator 297, and a motor 298.

The processor 210 (e.g., the processor 120) may include at least one application processor (AP) 211 or at least one communication processor (CP) 213. The processor 210 may be the processor 120 shown in FIG. 1, for example. Although the AP 211 and the CP 213 included in the processor 210 are shown in FIG. 2, they may be included in different Integrated Circuit (IC) packages. According to an embodiment of the present disclosure, the AP 211 and the CP 213 may be included in one IC package. The processor 210 determines whether a coordinate value of a preview area of a current frame and an immediately previous frame among a plurality of frames configuring a first image has a change of a less than a set value, adjusts a preview area of the first image to allow the preview area of the current frame to correspond to the preview image of the previous frame if there is the change of less than the set value, and adjusts the preview area of the second image by using a coordinate value adjusting the preview area of the first image. Additionally, the processor 210 may extract a coordinate value of a preview area of a plurality of frames configuring a first image and a second image. Additionally, the processor 210 may not adjust the preview image of the first image if there is a change of more than a set value. Additionally, the processor 210 compares a coordinate value of a preview area of a current frame with a coordinate value of a preview area of a previous frame and matches the coordinate value of the preview area of the current frame and the coordinate value of the preview area of the previous frame. Additionally, the processor 210 compares a coordinate value of a preview area of a current frame with a coordinate value of a preview area of a previous frame, calculates a changed coordinate value by comparing the coordinate value, and adjusts a preview area of a current frame of a second image to match a preview area of an immediately previous frame. Additionally, the processor 210 may move the preview area of the current frame of the second image by the change of the calculated coordinate value and may check that the moved preview area of the current frame matches the preview area of the immediately previous frame. Additionally, the processor 210 may not adjust the preview image of the first image if it is detected that the coordinate value of the preview area of the first image does not change among changes of less than a set value.

The AP 211 may control a plurality of hardware and/or software components connected to the AP 211 by executing an operating system and/or an application program and may perform various data processing and operations with multimedia data. The AP 211 may be implemented with a system on chip (SoC), for example. According to an embodiment of the present disclosure, the processor 210 may further include a graphic processing unit (GPU) (not shown).

The CP 213 may manage a data link in a communication between an electronic device (e.g., the electronic device 100) including the hardware 200 and other electronic devices connected via a network and may convert a communication protocol. The CP 213 may be implemented with a SoC, for example. According to an embodiment of the present disclosure, the CP 213 may perform at least part of a multimedia control function. The CP 213 may perform a distinction and authentication of a terminal in a communication network by using a subscriber identification module (e.g., the SIM card 214), for example. Additionally, the CP 213 may provide services, for example, a voice call, a video call, a text message, or packet data, to a user.

Additionally, the CP 213 may control the data transmission of the communication module 230. As shown in FIG. 2, components such as the CP 213, the power management module 295, or the memory 220 are separated from the AP 211, but according to an embodiment of the present disclosure, the AP 211 may be implemented including some of the above-mentioned components (e.g., the CP 213).

According to an embodiment of the present disclosure, the AP 211 and/or the CP 213 may load commands and/or data, which are received from a nonvolatile memory or at least one of other components connected thereto, into a volatile memory and may process them. Furthermore, the AP 211 and/or the CP 213 may store data received from or generated by at least one of other components in a nonvolatile memory.

The SIM card 214 may be a card implementing a subscriber identification module and may be inserted into a slot formed at a specific position of an electronic device. The SIM card 214 may include unique identification information (e.g., an integrated circuit card identifier (ICCID)) or subscriber information (e.g., an international mobile subscriber identity (IMSI)).

The memory 220 may include an internal memory 222 and/or an external memory 224. The memory 220 may be the memory 130 shown in FIG. 1, for example. The internal memory 222 may include at least one of a volatile memory (e.g., dynamic RAM (DRAM), static RAM (SRAM), synchronous dynamic RAM (SDRAM)) and a non-volatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, and NOR flash memory) According to an embodiment of the present disclosure, the internal memory 222 may have a form of Solid State Drive (SSD). The external memory 224 may further include compact flash (CF), secure digital (SD), micro secure digital (Micro-SD), mini secure digital (Mini-SD), extreme digital (xD), or memorystick. The memory 220 may store each extracted coordinate value.

The communication module 230 may include a wireless communication module 231 and/or an RF module 234. The communication module 230 may be the communication unit 160 shown in FIG. 1, for example. The wireless communication module 231 may include a WiFi 233, BT 235, a GPS 237, and/or a NFC 239. For example, the wireless communication module 231 may provide a wireless communication function by using a wireless frequency. Additionally or alternatively, the wireless communication module 231 may include a network interface (e.g., a LAN card) or a modem for connecting the hardware 200 to a network (e.g., Internet, LAN, WAN, telecommunication network, cellular network, satellite network, or POTS).

The RF module 234 may be responsible for data transmission, for example, the transmission of an RF signal or a called electrical signal. Although not shown in the drawings, the RF module 234 may include a transceiver, a power amp module (PAM), a frequency filter, or a low noise amplifier (LNA). The RF module 234 may further include components for transmitting/receiving electromagnetic waves on free space in a wireless communication, for example, conductors or conducting wires.

The sensor module 240 may include at least one of a gesture sensor 240A, a gyro sensor 240B, a pressure sensor 240C, a magnetic sensor 240D, an acceleration sensor 240E, a grip sensor 240F, a proximity sensor 240G, a red, green, blue (RGB) sensor 240H, a bio sensor 240I, a temperature/humidity sensor 240J, an illumination sensor 240K, and a ultra violet (UV) sensor 240M. The sensor module 240 measures physical quantities or detects an operating state of an electronic device, thereby converting the measured or detected information into electrical signals. Additionally/alternately, the sensor module 240 may include an E-nose sensor (not shown), an electromyography (EMG) sensor, an electroencephalogram (EEG) sensor (not shown), or an electrocardiogram (ECG) sensor (not shown). The sensor module 240 may further include a control circuit for controlling at least one sensor therein.

The user input unit 250 may include a touch panel 252, a (digital) pen sensor 254, a key 256, and/or an ultrasonic input device 258. The user input unit 250 may be the user input unit 140 shown in FIG. 1, for example. The touch panel 252 may recognize a touch input through at least one of a capacitive, resistive, infrared, or ultrasonic method, for example. Additionally, the touch panel 252 may further include a controller (not shown). In the case of the capacitive method, both direct touch and proximity recognition are possible. The touch panel 252 may further include a tactile layer. In this case, the touch panel 252 may provide a tactile response to a user.

The (digital) pen sensor 254 may be implemented through a method similar or identical to that of receiving a user's touch input or an additional sheet for recognition. As the key 256, a keypad or a touch key may be used, for example. The ultrasonic input device 258, as a device confirming data by detecting sound waves through a microphone (e.g., the microphone 288) in a terminal, may provide wireless recognition through a pen generating ultrasonic signals. According to an embodiment of the present disclosure, the hardware 200 may receive a user input from an external device (e.g., a network, a computer, and/or a server) connected to the hardware 200 through the communication module 230.

The display module 260 may include a panel 262 and/or a hologram 264. The display module 260 may be the display module 150 shown in FIG. 1, for example. The panel 262 may include a liquid-crystal display (LCD) or an active-matrix organic light-emitting diode (AM-OLED). The panel 262 may be implemented to be flexible, transparent, or wearable, for example. The panel 262 and the touch panel 252 may be configured with one module. The hologram 264 may show three-dimensional images in the air by using the interference of light. According to an embodiment of the present disclosure, the display module 260 may further include a control circuit for controlling the panel 262 or the hologram 264.

The interface 270 may include a high-definition multimedia interface (HDMI) 272, a universal serial bus (USB) 274, a projector 276, and/or a D-subminiature (sub) 278. Additionally or alternately, the interface 270 may include a secure Digital (SD)/multi-media card (MMC) (not shown) or an infrared data association (IrDA) (not shown).

The audio codec 280 may convert voice and electrical signals in both directions. The audio codec 280 may convert voice information inputted or outputted through a speaker 282, a receiver 284, an earphone 286, and/or a microphone 288.

The camera unit 291, as a device for capturing an image and video, may include at least one image sensor (e.g., a front lens or a rear lens), an image signal processor (ISP) (not shown), or a flash LED (not shown).

The power management module 295 may manage the power of the hardware 200. Although not shown in the drawings, the power management module 295 may include a power management integrated circuit (PMIC), a charger integrated circuit (IC), or a battery fuel gauge.

The PMIC may be built in an IC or SoC semiconductor, for example. A charging method may be classified as a wired method and a wireless method. The charger IC may charge a battery and may prevent overvoltage or overcurrent flow from a charger. According to an embodiment of the present disclosure, the charger IC may include a charger IC for at least one of a wired charging method and a wireless charging method. As the wireless charging method, for example, there is a magnetic resonance method, a magnetic induction method, or an electromagnetic method. An additional circuit for wireless charging, for example, a circuit such as a coil loop, a resonant circuit, or a rectifier circuit, may be added.

A battery gauge may measure the remaining amount of the battery 296, or a voltage, current, or temperature thereof during charging. The battery 296 may generate electricity and supplies power. For example, the battery 296 may be a rechargeable battery.

The indicator 297 may display a specific state of the hardware 200 or part thereof (e.g., the AP 211), for example, a booting state, a message state, or a charging state. The motor 298 may convert electrical signals into mechanical vibration. The processor 210 may control the sensor module 240.

Although not shown in the drawings, the hardware 200 may include a processing device (e.g., a GPU) for mobile TV support. A processing device for mobile TV support may process media data according to the standards such as digital multimedia broadcasting (DMB), digital video broadcasting (DVB), or media flow.

The names of the above-mentioned components in hardware according to an embodiment of the present disclosure may vary according to types of an electronic device. Hardware according to an embodiment of the present disclosure may be configured including at least one of the above-mentioned components or additional other components. Additionally, some of components in hardware according to an embodiment of the present disclosure are configured as one entity, so that functions of previous corresponding components are performed identically.

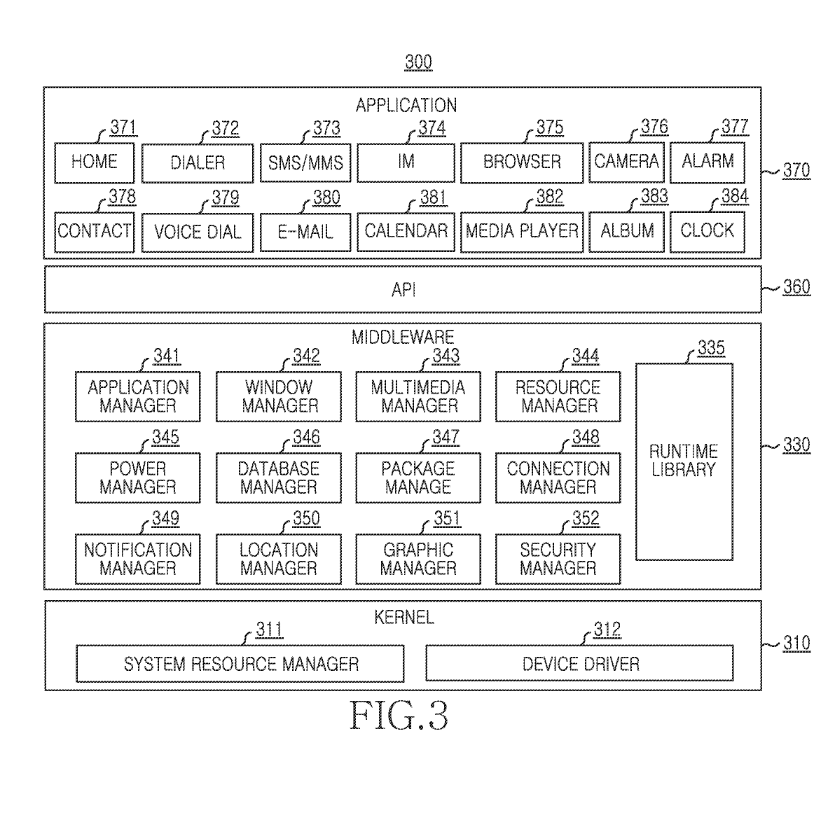

FIG. 3 is a block diagram of a programming module according to an embodiment of the present disclosure.

Referring to FIG. 3, a programming unit 300 may be included (e.g., stored) in the electronic device 100 (e.g., the memory 130) of FIG. 1. At least part of the programming module 300 may be configured with software, firmware, hardware, or a combination thereof. The programming module 300 may include an operating system (OS) controlling a resource relating to an electronic device (e.g., the electronic device 100) implemented in hardware (e.g., the hardware 200) or various applications (e.g., the application 370) running on the OS. For example, the OS may include Android, iOS, Windows, Symbian, Tizen, or Bada. Referring to FIG. 3, the programming module 300 may include a kernel 310, a middleware 330, an application programming interface (API) 360, and/or an application 370.

The kernel 310 (e.g., the kernel 131) may include a system resource manager 311 and/or a device driver 312. The system resource manager 311 may include a process management unit (not shown), a memory management unit (not shown), or a file system management unit (not shown), for example. The system resource manager 311 may perform control, allocation, and/or recovery of a system resource. The device driver 312 may include a display driver (not shown), a camera driver (not shown), a Bluetooth driver (not shown), a sharing memory driver (not shown), a USB driver (not shown), a keypad driver (not shown), a keypad driver (not shown), a WiFi driver (not shown), or an audio driver (not shown). Additionally, according to an embodiment of the present disclosure, the device driver 312 may include an inter-processing communication (IPC) driver (not shown).

The middleware 330 may include a plurality of pre-implemented modules for providing functions that the application 370 commonly requires. Additionally, the middleware 330 may provide functions through the API 360 to allow the application 370 to efficiently use a limited system resource in an electronic device. For example, as shown in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and/or a security manager 352.

The runtime library 335 may include a library module in which a compiler is used to add a new function through programming language while the application 370 is executed. According to an embodiment of the present disclosure, the runtime library 335 may perform functions relating to an input/output, memory management, or calculation operation.

The application manager 341 may manage a life cycle of at least one application among the applications 370. The window manager 342 may manage a GUI resource using a screen. The multimedia manager 343 may recognize a format necessary for playing various media files and may perform encoding or decoding on a media file by using codec appropriate for a corresponding format. The resource manager 344 may manage a resource such as source code, memory, or storage space of at least one application among the applications 370.

The power manager 345 manages a battery or power in operation with basic input/output system (BIOS) and provides power information necessary for an operation. The database manager 346 may perform a management operation to generate, search or change a database used for at least one application among the applications 370. The package manager 347 may manage the installation and/or update of an application distributed in a package file format.

The connectivity manager 348 may manage a wireless connection such as WiFi or Bluetooth. The notification manager 349 may display or notify events such as arrival messages, appointments, and proximity alerts in a manner that is not disruptive to a user. The location manager 350 may manage location information of an electronic device. The graphic manager 351 may manage an effect to be provided to a user or a user interface relating thereto. The security manager 352 may provide a general security function necessary for system security or user authentication. According to an embodiment of the present disclosure, when an electronic device (e.g., the electronic device 100) has a call function, the middleware 330 may further include a telephony manager (not shown) for managing a voice or video call function of the electronic device.

The middleware 330 may generate and use a new middleware module through various function combinations of the above-mentioned internal component modules. The middleware 330 may provide modules specified according to types of an OS so as to provide distinctive functions. Additionally, the middleware 330 may delete some existing components or add new components dynamically. Accordingly, some components listed in an embodiment of the present disclosure may be omitted, other components are added, or components having different names but performing similar functions may be substituted.

The API 360 (e.g., the API 133) may be provided as a set of API programming functions with a different configuration according OS. For example, in the case of Android or iOS, for example, one API set may be provided by each platform, and in the case of Tizen, for example, more than two API sets may be provided.

The application 370 (e.g., the application 134), for example, may include a preloaded application or a third party application. The application 370 may include one or more of a Home function 371, a dialer 372, a Short Message Service (SMS)/Multimedia Message Service (MMS) 373, an Instant Message service 374, a browser 375, a camera application 376, an alarm 377, a contacts application 378, a voice dial function 379, an email application 380, a calendar 381, a media player 382, an album 383, and/or a clock 384.

At least part of the programming module 300 may be implemented using a command stored in computer-readable storage media. When an instruction is executed by at least one processor (e.g., the processor 210), the at least one processor may perform a function corresponding to the instruction. The computer-readable storage media may include the memory 260, for example. At least part of the programming module 300 may be implemented (e.g., executed) by the processor 210, for example. At least part of the programming module 300 may include a module, a program, a routine, sets of instructions, or a process to perform at least one function, for example.

The names of components of a programming module (e.g., the programming unit 300) according to an embodiment of the present disclosure may vary according to types of OS. Additionally, a programming module may include at least one of the above-mentioned components or additional other components. Or, part of the programming module may be omitted.

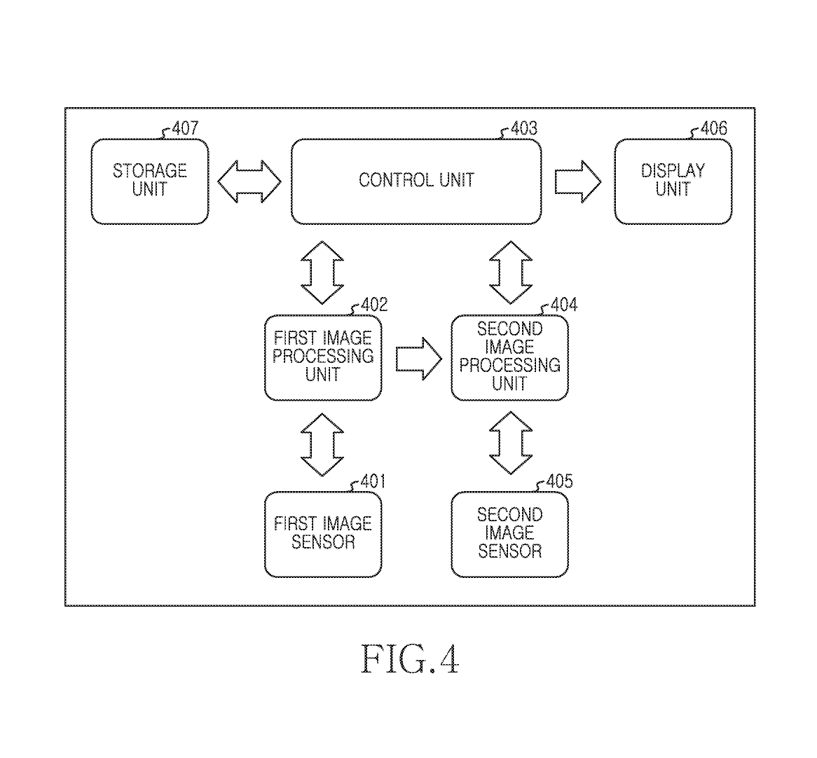

FIG. 4 is a block diagram illustrating a configuration of an electronic device according to an embodiment of the present disclosure.

Referring to FIG. 4, the electronic device may include a first image sensor 401, a first image processing unit 402, a control unit 403, a second image processing unit 404, a second image sensor 405, a display unit 406, and a storage unit 407.

First, the first image sensor 401 may be a sensor sensing an image being captured by a camera. In more detail, the first image sensor 401 may be a sensor sensing an image being captured by a first camera in a dual camera equipped in the electronic device.

The first image processing unit 402 may process an image sensed by the first image sensor 401. In more detail, the first image processing unit 402 is connected to the first image sensor 401 and processes an image received from the first image sensor 401 according to a set method.

Additionally, the first image processing unit 402 may correct the blur on an image received from the first image sensor 401.

Additionally, after correcting the blur on an image received from the first image sensor 401, the first image processing unit 402 may deliver a coordinate value of a preview area to be changed to the second image processing unit 404. Here, the first image processing unit 402 may directly deliver a coordinate value of a preview area to be changed to the second image processing unit 404 and may deliver the coordinate value to the second image processor 404 through the control unit 403.

The control unit 403 may generate an image obtained by synthesizing images, which are processed by the first image processing unit 402 and the second image processing unit 404, in a predetermined form. Here, in the control unit 403, the synthesized images may be images sensed by the first image sensor 401 and the second image sensor 405.

Additionally, the control unit 403 may display image information received through the first image processing unit 402 and the second image processing unit 404, on the display unit 406.

Additionally, the control unit 403 may receive images stored in the storage unit 407 from the storage unit 407.

Additionally, the control unit 403 may store images synthesized by the control unit 403 in the storage unit 407.

Additionally, the control unit 403 may receive a preview coordinate value corrected for the blur by the first image processing unit 402 from the first image processing unit 402 and may then display the corrected preview coordinate value to the second image processing unit 404.

The second image processing unit 404 may process an image sensed by the second image sensor 405. In more detail, the second image processing unit 404 is connected to the second image sensor 405 and processes an image received from the second image sensor 405 according to a set method.

Additionally, the second image processing unit 404 may receive a preview coordinate value corrected for the blur from the first image processing unit 402 or the control unit 403.

The second image sensor 405 may be a sensor sensing an image being captured by a camera. In more detail, the second image sensor 405 may be a sensor sensing an image being captured by a second camera in a dual camera equipped in the electronic device.

The display unit 406 may output images synthesized a control of the control unit 403. Additionally, the display unit 406 may output at least part of images used for each image. Here, the display unit 406 may be a means for displaying an image, for example, a Cathode-Ray Tube (CRT), a LCD, a Light Emitting Diode (LED), an Organic Light Emitting Diode, and a Plasma Display Panel (PDP), which display an inputted image signal.

The storage unit 407 may deliver stored images to the control unit 403 and may store images received through a communication unit (not shown) or may store images synthesized by the control unit 403. Here, the storage unit 407 may be a storage means such as flash memory, memory chip, or hard disk.

In the above-mentioned block configuration, the control unit 403 may perform overall functions of the electronic device. The present disclosure configures and shows them separately to describe each function distinguishingly. Accordingly, when actual product is realized, the control unit 403 may be configured to process all functions of the electronic device or may be configured to process some of functions.

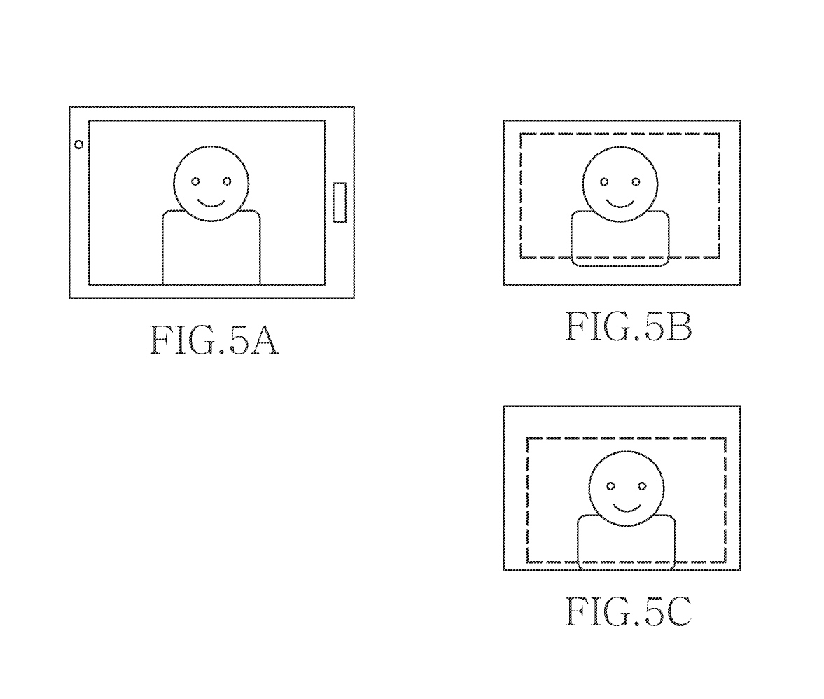

FIGS. 5A, 5B and 5C are views illustrating an operation for adjusting a preview area of an image captured by a first camera according to an embodiment of the present disclosure. The electronic device is an electronic device equipped with a dual camera. That is, the electronic device is equipped with a dual camera that simultaneously captures a first subject and a second subject, i.e. different subjects. Hereinafter, among a first camera and a second camera equipped in the electronic device, an operation of the first camera is described in more detail.

First, the electronic device may display a first image being captured through the first camera, on a display module. The electronic device may display a first image being captured through the first camera, on a display module by executing a camera module.

Then, the electronic device may determine whether a coordinate value of a preview area of a current frame and an immediately previous frame among a plurality of frames has a change of less than a set value. In more detail, the electronic device may determine whether there is a change in a coordinate value of less than a set value by comparing changes in the coordinate value of the preview area of the current frame being displayed and the immediately previous frame.

Here, when determining whether there is a change in a coordinate value of less than a set value, the electronic device may use at least one equipped sensor sensing a movement of the electronic device. For example, a sensor equipped in an electronic device to sense a movement may be at least one of a gyro sensor, an acceleration sensor, a gravitational sensor, and a displacement sensor.

If it is determined that there is a change in a coordinate value of less than a set value in an electronic device, the electronic device may adjust a preview image of a first image so as to match a preview area of a current frame and a preview area of a previous frame. In more detail, the electronic device compares a coordinate value of a preview area of a current frame with a coordinate value of a preview area of a previous frame and matches the coordinate value of the preview area of the current frame and the coordinate value of the preview area of the previous frame.

Referring to FIG. 5A, the case in which an electronic device displays a first image on a display module by using a first camera of the electronic device is illustrated. Additionally, the case in which a preview area being displayed moves downward due to the trembling of the hands of a user supporting the electronic device is used as an example.

In the above-example, the electronic device may compare a coordinate value of a preview area of a downwardly moved frame with a coordinate value of a preview area of an immediately previous frame. Then, if it is determined that there is a change in a coordinate value of less than a set value in an electronic device, the electronic device may adjust a preview image of a first image so as to match a preview area of a current frame and a preview area of a previous frame.

Referring to in FIG. 5B, when a preview image moves downward due to the trembling of the hands of a user, the electronic device may move the coordinate value of the preview area of the current frame to match the coordinate value of the preview area of the immediately previous frame. Accordingly, from a user's perspective, even when an electronic device shakes downward finely, since this matches a preview area of a previous frame, it is not detected that an image being displayed shakes downward.

For another example, as shown in FIG. 5A, the case in which an electronic device displays a first image on a display module by using a first camera of the electronic device is described. Additionally, the case in which a preview area being displayed moves upward due to the trembling of the hands of a user supporting the electronic device is used as an example.

In the above-example, the electronic device may compare a coordinate value of a preview area of an upwardly moved frame with a coordinate value of a preview area of an immediately previous frame. Then, if it is determined that there is a change in a coordinate value of less than a set value in an electronic device, the electronic device may adjust a preview image of a first image so as to match a preview area of a current frame and a preview area of a previous frame.

Referring to FIG. 5C, when a preview image moves upward due to the trembling of the hands of a user, the electronic device may move the coordinate value of the preview area of the current frame to match the coordinate value of the preview area of the immediately previous frame. Accordingly, from a user's perspective, even when an electronic device shakes upward finely, since this matches a preview area of a previous frame, it is not detected that an image being displayed shakes upward.

This embodiment describes the case for correcting the shaking when an electronic device shakes upwardly or downwardly but also may be applied to the case in which an electronic device shakes in a horizontal or diagonal direction.

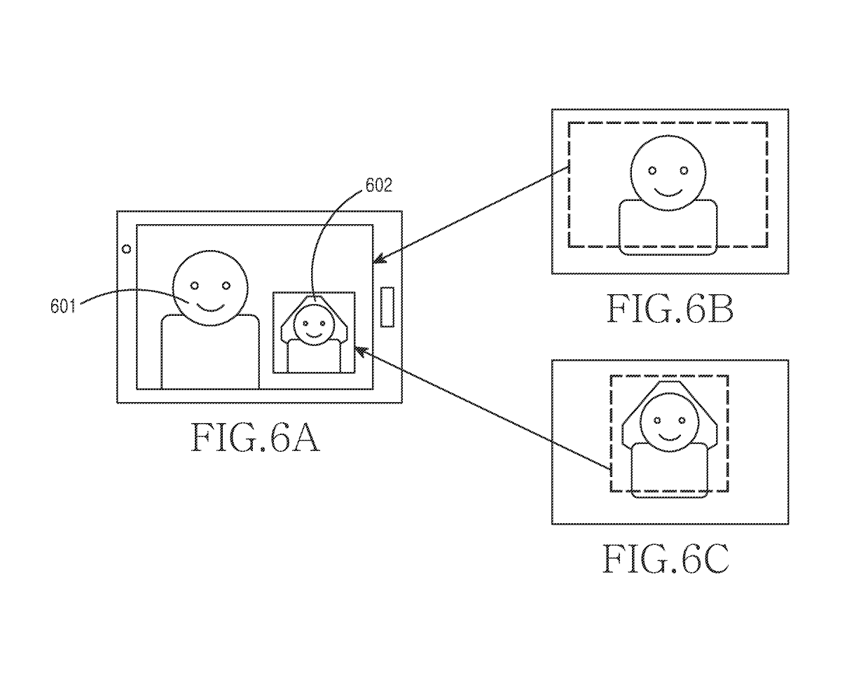

FIGS. 6A, 6B and 6C are views illustrating an operation for adjusting a preview area of a second image by using a coordinate value adjusting a preview area of a first image according to an embodiment of the present disclosure.

Referring to FIG. 6A, the electronic device may display a subject being captured by each camera on a display module of the electronic device by using a dual camera equipped in the electronic device. For example, the electronic device may display a first image for a first subject 601 being captured through a first camera on a set first area and may display a second image for a second object 602 being captured through a second camera on a set second area simultaneously.

Then, the electronic device may determine whether a coordinate value of a preview area of a current frame and an immediately previous frame among a plurality of frames has a change of less than a set value. In more detail, the electronic device may determine whether there is a change in a coordinate value of less than a set value by comparing changes in the coordinate value of the preview area of the current frame being displayed and the immediately previous frame.

If it is determined that there is a change in a coordinate value of less than a set value in an electronic device, the electronic device may adjust a preview image of a first image so as to match a preview area of a current frame and a preview area of a previous frame. In more detail, the electronic device compares a coordinate value of a preview area of a current frame with a coordinate value of a preview area of a previous frame and matches the coordinate value of the preview area of the current frame and the coordinate value of the preview area of the previous frame.

Then, the electronic device may adjust a preview area of a second image by using a coordinate value adjusting a preview area of a first image. In more detail, the electronic device compares a coordinate value of a preview area of a current frame of the first image with a coordinate value of a preview area of a previous frame of the first image and then, adjust a preview area of a current frame of the second image to match a preview area of an immediately previous frame by using the calculated coordinate value.

Referring to FIGS. 6B and 6C, the case in which an electronic device displays a first image and a second image on a display module by using a dual camera equipped in the electronic device is illustrated. Additionally, the case in which a preview area being displayed moves downward due to the trembling of the hands of a user supporting the electronic device is used as an example.

In the above-example, the electronic device may compare a coordinate value of a preview area of a downwardly moved frame with a coordinate value of a preview area of an immediately previous frame. Then, if it is determined that there is a change in a coordinate value of less than a set value in an electronic device, the electronic device may adjust a preview image of a first image so as to match a preview area of a current frame and a preview area of a previous frame. That is, as shown in FIG. 6B, when a preview image moves downward due to the trembling of the hands of a user, the electronic device may move the coordinate value of the preview area of the current frame to match the coordinate value of the preview area of the immediately previous frame.

Then, the electronic device compares a coordinate value of a preview area of a current frame of the first image with a coordinate value of a preview area of a previous frame of the first image and then, adjust a preview area of a current frame of the second image to match a preview area of an immediately previous frame by using the calculated coordinate value. That is, as shown in FIG. 6C, the electronic device may move a preview area by a coordinate value to match a preview image of a current frame of the second image and a preview area of an immediately previous frame by using a coordinate value used for correcting a preview area of a first image. Accordingly, the electronic device may adjust a preview area of a second image simultaneously by correcting only a coordinate value of a preview area of a first image.

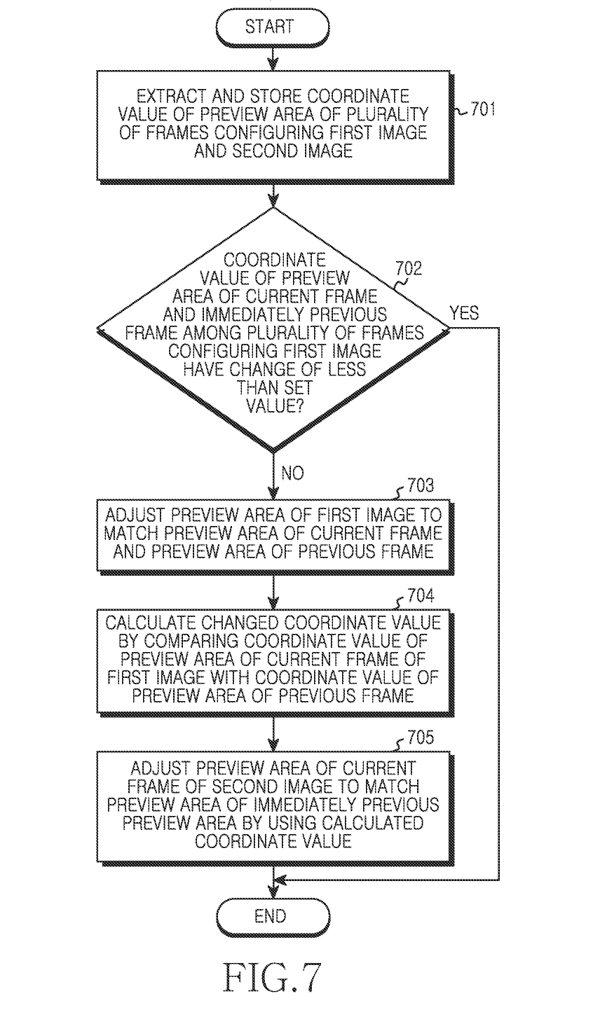

FIG. 7 is a flowchart illustrating an operation order of an electronic device according to an embodiment of the present disclosure.

Referring to FIG. 7, the electronic device may extract a coordinate value of a preview area of a plurality of frames configuring a first image and a second image and may then store the a coordinate value of a preview area of a plurality of frames in operation 701. In more detail, the electronic device may capture a first subject and a second subject, i.e., different subjects, simultaneously, and then may extract and store a coordinate value of a preview area of a plurality of frames configuring a first image and a second image.

Then, the electronic device may determine whether a coordinate value of a preview area of a current frame and an immediately previous frame among a plurality of frames configuring a first image has a change of less than a set value in operation 702. In more detail, the electronic device may determine whether there is a change in a coordinate value of less than a set value by comparing changes in the coordinate value of the preview area of the current frame being displayed and the immediately previous frame.

If the electronic device determines that a coordinate value of a preview area of a current frame and an immediately previous frame among a plurality of frames configuring a first image has a change of less than a set value in operation 702, the electronic device may adjust a preview area of a first image so as to match a preview area of a current frame and a preview area of a previous frame in operation 703. For example, when the electronic device senses a change in a coordinate value of a preview area of less than a set value due to the trembling of the hands of a user supporting the electronic device, the electronic device may adjust a preview image of a first image so as to match a preview area of a current frame and a preview area of a previous frame.

Then, the electronic device may calculate a changed coordinate value by comparing a coordinate value of a preview area of a current frame of a first image with a coordinate value of a preview area of a previous frame in operation 704. For example, if moving upward by a size “a” from the center coordinate of a previous frame, the electronic device may calculate a coordinate value that the center coordinate value of a preview area of a current frame is changed by the size “a” from a coordinate value of a preview area of the previous frame.

Then, the electronic device may adjust a preview area of a current frame of a second image to match a preview area of an immediately previous area by using the calculated coordinate value in operation 705. In the above-mentioned example, since a preview area of a first frame moves upward by the size “a”, the electronic device may adjust a coordinate value of a preview area of a second frame to move downward by the size “a”.

If the electronic device determines that a coordinate value of a preview area of a current frame and an immediately previous frame among a plurality of frames configuring a first image has no change of less than a set value in operation 702, the electronic device may not adjust both a preview area of a second image and the first image. This is because if it is determined that there is a change of more than a set value, a user changes a subject to be captured. That is, if a change of more than a set value is detected in the electronic device, the electronic device determines that image shaking is not due to the trembling of the hands of a user.

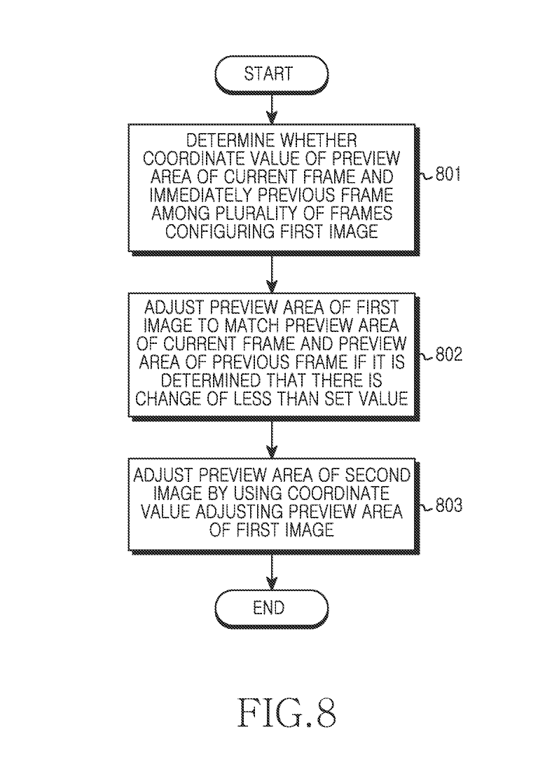

FIG. 8 is a flowchart illustrating a method of an electronic device according to an embodiment of the present disclosure.

Referring to FIG. 8, the electronic device may determine whether a coordinate value of a preview area of a current frame and an immediately previous frame among a plurality of frames confirming a first image has a change of less than a set value in operation 801. In more detail, the electronic device may determine whether there is a change in a coordinate value of less than a set value by comparing changes in the coordinate value of the preview area of the current frame being displayed and the immediately previous frame.

Then, if it is determined that there is a change in a coordinate value of less than a set value, the electronic device may adjust a preview image of a first image so as to match a preview area of a current frame and a preview area of a previous frame in operation 802. In more detail, the electronic device compares a coordinate value of a preview area of a current frame with a coordinate value of a preview area of a previous frame and matches the coordinate value of the preview area of the current frame and the coordinate value of the preview area of the previous frame.

Then, the electronic device may adjust a preview area of a second image by using a coordinate value adjusting a preview area of a first image in operation 803. In more detail, the electronic device compares a coordinate value of a preview area of a current frame of the first image with a coordinate value of a preview area of a previous frame of the first image and then, adjusts a preview area of a current frame of the second image to match a preview area of an immediately previous frame by using the calculated coordinate value.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

It will be appreciated that embodiments of the present disclosure according to the claims and description in the specification may be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure.

Accordingly, embodiments provide a program comprising code for implementing apparatus or a method as claimed in any one of the claims of this specification and a machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of adjusting a preview area of images in an electronic device, the method comprising:
detecting whether a coordinate value of a current frame and an immediately previous frame among a plurality of frames configuring a first image has a change of less than a set value;
adjusting a preview area of the first image to match a preview area of the current frame and a preview area of the immediately previous frame when it is determined that the there is the change of less than the set value; and
adjusting a preview area of a second image by using a coordinate value adjusting the preview area of the first image.

2. The method of claim 1, further comprising:
extracting a coordinate value of a preview area of the plurality of frames configuring the first image and the second image; and
storing each of the extracted coordinate value.

3. The method of claim 1, wherein the determining of whether there is the change of less than the set value comprises determining whether there is the change of less than the set value by using at least one sensor equipped to sense a movement.

4. The method of claim 3, wherein the sensor comprises at least one of a gyro sensor, an acceleration sensor, a gravitational sensor, and a displacement sensor.

5. The method of claim 1, further comprising, not adjusting when it is determined that there is the change of more than the set value, the preview area of the first image.

6. The method of claim 1, wherein the adjusting of the preview area of the first image comprises:
comparing a coordinate value of the preview area of the current frame with a coordinate value of the preview area of the immediately previous frame; and
matching the coordinate value of the preview area of the current frame and the coordinate value of the preview area of the immediately previous frame.

7. The method of claim 1, wherein the adjusting of the preview area of the second image comprises:
comparing a coordinate value of the preview area of the current frame of the first image and a coordinate value of the preview area of the previous frame of the first image;
calculating a changed coordinate value by comparing the calculated coordinate values; and
adjusting the preview area of the current frame of the second image to match the preview area of the immediately previous frame by using the calculated coordinate value.

8. The method of claim 7, wherein the adjusting of the preview area of the current frame of the second image to match the preview area of the immediately previous frame by using the calculated coordinate value comprises:
moving the preview area of the current frame of the second image by a change of the calculated coordinate value; and
checking whether the moved preview area of the current frame matches the preview area of the immediately previous frame.

9. The method of claim 1, wherein the first image and the second image are displayed in respective areas in a Picture In Picture (PIP) format.

10. The method of claim 1, further comprising, when it is detected that the coordinate value of the preview area of the first image does not change within the change of less than the set value, not adjusting the preview area of the first image.

11. An electronic device comprising:
a processor configured to detect whether a coordinate value of a current frame and an immediately previous frame among a plurality of frames configuring a first image has a change of less than a set value, adjust a preview area of the first image to match a preview area of the current frame and a preview area of the immediately previous frame when it is determined that the there is the change of less than the set value, and adjust a preview area of a second image by using a coordinate value adjusting the preview area of the first image; and
a memory configured to store data controlled by the processor.

12. The device of claim 11, wherein
the processor extracts a coordinate value of a preview area of the plurality of frames configuring the first image and the second image; and
the memory stores each of the extracted coordinate value.

13. The device of claim 11, further comprising at least one sensor configured to determine whether there is the change of less than the set value by sensing a movement.

14. The device of claim 13, wherein the sensor comprises at least one of a gyro sensor, an acceleration sensor, a gravitational sensor, and a displacement sensor.

15. The device of claim 11, wherein, when it is determined that there is the change of more than the set value, the processor does not adjust the preview area of the first image.

16. The device of claim 11, wherein the processor compares a coordinate value of the preview area of the current frame with a coordinate value of the preview area of the immediately previous frame and matches the coordinate value of the preview area of the current frame and the coordinate value of the preview area of the immediately previous frame.

17. The device of claim 11, wherein the processor compares a coordinate value of the preview area of the current frame of the first image and a coordinate value of the preview area of the previous frame of the first image, calculates a changed coordinate value by comparing the calculated coordinate values, and adjust the preview area of the current frame of the second image to match the preview area of the immediately previous frame by using the calculated coordinate value.

18. The device of claim 17, wherein the processor moves the preview area of the current frame of the second image by a change of the calculated coordinate value and checks whether the moved preview area of the current frame matches the preview area of the immediately previous frame.

19. The device of claim 11, wherein the first image and the second image are displayed in respective areas in a Picture In Picture (PIP) format.

20. The device of claim 11, wherein, when it is detected that the coordinate value of the preview area of the first image does not change within the change of less than the set value, the processor does not adjust the preview area of the first image.

21. The device of claim 11, wherein the set value is determined by determining a coordinate value change that indicates an intended movement of a user of the electronic device.
